(19) United States
(12) Patent Application Publication
(10) Pub. No.: US 2020/0175474 A1
(43) Pub. Date: Jun. 4, 2020

(54) INFORMATION PROCESSING SYSTEM, PROGRAM, AND CONTROL METHOD

(71) Applicant: TOYOTA JIDOSHA KABUSHIKI KAISHA, Toyota-shi (JP)

(72) Inventors: Kana HAMAGAMI, Nissin-shi (JP); Takuya MAEKAWA, Nissin-shi (JP); Yosuke NAKAYAMA, Owariasahi-shi (JP); Akitoshi JIKUMARU, Nissin-shi (JP); Tae SUGIMURA, Miyoshi-shi (JP); Takao HISHIKAWA, Nagoya-shi (JP); Shinichi ADACHI, Takahama-shi (JP)

(73) Assignee: TOYOTA JIDOSHA KABUSHIKI KAISHA, Toyota-shi (JP)

(21) Appl. No.: 16/656,652

(22) Filed: Oct. 18, 2019

(30) Foreign Application Priority Data
Dec. 3, 2018 (JP) 2018-226451

(51) Int. Cl. G06Q 10/10; G06Q 40/08; G06K 9/00; G08G 1/01; B60W 40/09

(52) U.S. Cl. CPC G06Q 10/10; G06Q 40/08; B60W 40/09; G08G 1/0112; G06K 9/00791

(57) ABSTRACT

An information processing system includes a vehicle and a server communicatively connected with the vehicle. The vehicle is configured to acquire a traveling state of the vehicle, acquire information on an occupant of the vehicle, and detect an occurrence of a traffic accident related to the vehicle. The server is configured to store provision information including a damage state of the vehicle due to the traffic accident analyzed based on the traveling state of the vehicle and an injury state of the occupant due to the traffic accident analyzed based on the information on the occupant when the server receives a notification of the occurrence of the traffic accident from the vehicle, and provides the provision information to an insurance company.

### INCORPORATION BY REFERENCE

The disclosure of Japanese Patent Application No. 2018-226451 filed on Dec. 3, 2018 including the specification, drawings and abstract is incorporated herein by reference in its entirety.

### BACKGROUND

### 1. Technical Field

The present disclosure relates to an information processing system, a program, and a control method.

### 2. Description of Related Art

In the related art, a technique that decides a contract content of insurance contracted by a driver of a vehicle based on an excellence level of the driver is known. For example, WO 2008/038340 discloses an insurance information output method of detecting a behavior of a moving object to acquire hazard information, and determining an excellence level of an insured person regarding the use of the moving object based on the hazard information.

### SUMMARY

In general, an insurance company also provides an insured person with a traffic accident response service that provides a countermeasure to a party when a traffic accident occurs, in addition to providing compensation based on a contract content. At this time, it is desirable to appropriately decide a content of the countermeasure provided by the insurance company to the party.

The present disclosure provides an information processing system, a program, and a control method capable of contributing to an appropriate decision of a countermeasure provided by an insurance company to a party when a traffic accident occurs.

A first aspect of the present disclosure relates to an information processing system. The information processing system includes a vehicle and a server communicatively connected with the vehicle. The vehicle is configured to acquire a traveling state of the vehicle, acquire information on an occupant of the vehicle, and detect an occurrence of a traffic accident related to the vehicle. The server is configured to, when a notification of the occurrence of the traffic accident is received from the vehicle, store provision information including a damage state of the vehicle due to the traffic accident analyzed based on the traveling state of the vehicle and an injury state of the occupant due to the traffic accident analyzed based on the information on the occupant, and provide the provision information to an insurance company.

A second aspect of the present disclosure relates to a program that operates in an information processing system including a vehicle and a server communicatively connected with the vehicle. The program causes the vehicle to execute a step of acquiring a traveling state of the vehicle, a step of acquiring information on an occupant of the vehicle, and a step of detecting an occurrence of a traffic accident related to the vehicle. The program causes the server to execute a step of receiving a notification of the occurrence of the traffic accident from the vehicle and a step of storing provision information including a damage state of the vehicle due to the traffic accident analyzed based on the traveling state of the vehicle and an injury state of the occupant due to the traffic accident analyzed based on the information on the occupant, and providing the provision information to an insurance company.

A third aspect of the present disclosure relates to a control method in an information processing system including a vehicle and a server communicatively connected with the vehicle. The control method includes, in the vehicle, a step of acquiring a traveling state of the vehicle, a step of acquiring information on an occupant of the vehicle, and a step of detecting an occurrence of a traffic accident related to the vehicle. The control method includes, in the sewer, a step of receiving a notification of the occurrence of the traffic accident from the vehicle and a step of storing provision information including a damage state of the vehicle due to the traffic accident analyzed based on the traveling state of the vehicle and an injury state of the occupant due to the traffic accident analyzed based on the information on the occupant, and providing the provision information to an insurance company.

With the information processing system, the program, and the control method according to the aspects of the present disclosure, it is possible to contribute to an appropriate decision of a countermeasure provided by an insurance company to a party when a traffic accident occurs.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a diagram showing a schematic configuration of an information processing system according to an embodiment of the present disclosure;

FIG. 2 is a block diagram showing a schematic configuration of a vehicle;

FIG. 3 is a block diagram showing a schematic configuration of a server;

FIG. 4 is a table showing a specific example of provision information stored in a storage unit of the server; and

FIG. 5 is a sequence diagram showing an example of a flow of an operation of the information processing system.

### DETAILED DESCRIPTION OF EMBODIMENTS

Hereinafter, an embodiment of the present disclosure will be described with reference to the accompanying drawings.

Information Processing System

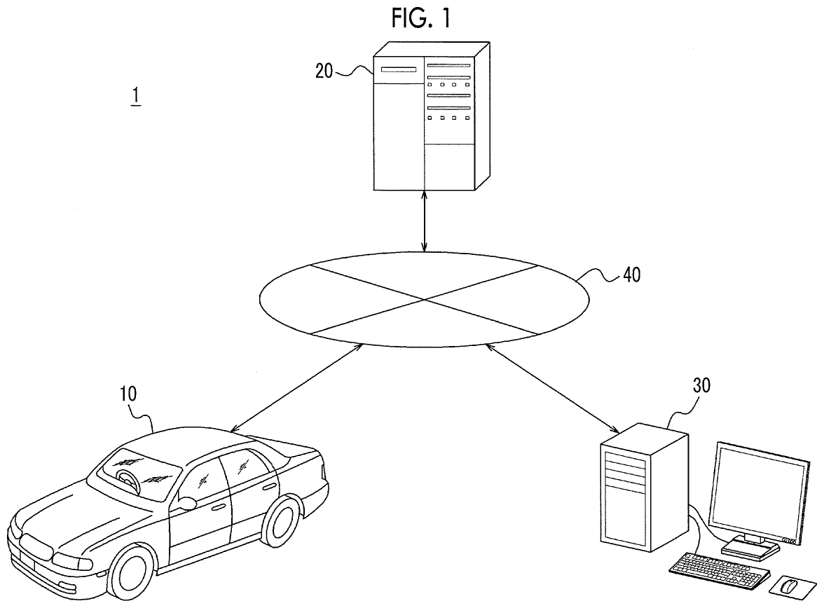

FIG. 1 is a diagram showing a schematic configuration of an information processing system 1 according to an embodiment of the present disclosure. The configuration and functions of the information processing system 1 according to the embodiment of the present disclosure will be described with reference to FIG. 1.

The information processing system 1 includes a vehicle 10, a server 20, and an information processing terminal 30 of an insurance company. Each of the vehicle 10, the server 20, and the information processing terminal 30 is communicatively connected with a network 40 including, for example, a mobile communication network and the Internet. For example, the vehicle 10 and the server 20 are communicatively connected with each other through the network 40. For example, the server 20 and the information processing terminal 30 are communicatively connected with each other through the network 40.

The vehicle 10 is, for example, an automobile, but is not limited thereto, and may be any vehicle for a human to get in. The vehicle 10 is a vehicle driven by a driver, but is not limited thereto, and may be, for example, a vehicle that performs an autonomous driving. The autonomous driving includes, for example, levels 1 to 5 defined in Society of Automotive Engineers (SAE), but is not limited thereto, and may be optionally defined. Solely one vehicle 10 is exemplified in FIG. 1 for convenience of the description, but the number of vehicles 10 included in the information processing system 1 may be one or more.

The server 20 is, for example, a general-purpose information processing device having a function as a server device. The server 20 is not limited thereto, and may be another information processing device dedicated to the information processing system 1. Solely one server 20 is exemplified in FIG. 1 for convenience of the description, but the number of servers 20 included in the information processing system 1 may be one or more.

The information processing terminal 30 is, for example, a personal computer (PC) owned by an insurance company. The information processing terminal 30 is not limited thereto, and may be a smartphone of an employee in the insurance company or may be a server device used by the insurance company. The insurance company is any insurance company that provides a countermeasure to the party when a traffic accident related to the vehicle 10 occurs. The party is an occupant of the vehicle 10 as an insured person who has contracted an insurance, such as an automobile insurance, with the insurance company. The party is not limited thereto, and may be an occupant of the vehicle 10 who is not entered into an insurance contract as the insured person but can receive the provision of the countermeasure as a service from the insurance company and may be an occupant of another vehicle that has caused the traffic accident with the vehicle 10.

As an outline of the embodiment, the server 20 acquires a traveling state of the vehicle 10 and information on the occupant of the vehicle 10 from the vehicle 10 through the network 40. The occupant of the vehicle 10 includes the driver and the passenger of the vehicle 10. The number of occupants of the vehicle 10 may be one or more. When a notification of the occurrence of the traffic accident related to the vehicle 10 is received from the vehicle 10, the server 20 generates and stores provision information including a damage state of the vehicle 10 due to the traffic accident analyzed based on the traveling state of the vehicle 10 and an injury state of the occupant of the vehicle 10 due to the traffic accident analyzed based on the information on the occupant. The server 20 provides the generated provision information to the insurance company.

Thus, according to the embodiment, the information processing system 1 can provide the insurance company with the provision information including the damage state of the vehicle 10 and the injury state of the occupant of the vehicle 10 due to the occurrence of the traffic accident. For example, even in a case where the party is confused by the occurrence of the traffic accident and it is difficult to directly grasp a damage situation and an injury situation caused by the traffic accident from the party, the insurance company can appropriately grasp these situations based on the provision information from the information processing system 1. The insurance company can provide the party of the traffic accident with an appropriate countermeasure for the traffic accident that occurred with respect to the vehicle 10, while also referring to the provision information accumulated regarding the past traffic accident.

Next, each configuration of the information processing system 1 will be described in detail.

Vehicle

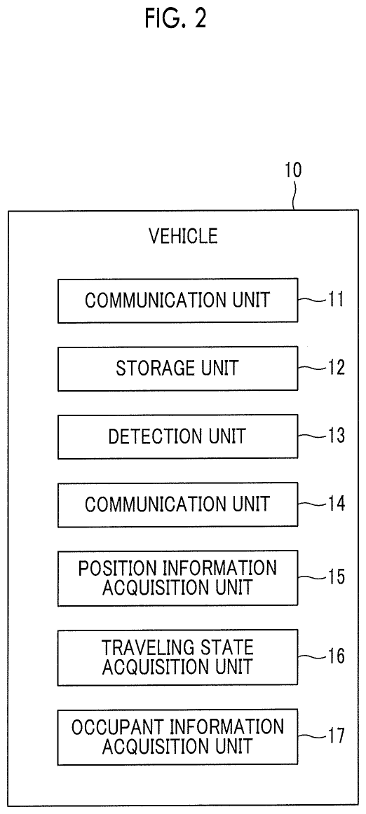

FIG. 2 is a block diagram showing a schematic configuration of the vehicle 10. As shown in FIG. 2, the vehicle 10 includes a controller 11, a communication unit 12, a storage unit 13, a detection unit 14, a position information acquisition unit 15, a traveling state acquisition unit 16, and an occupant information acquisition unit 17. The constituent units constituting the vehicle 10 are communicatively connected with one another through, for example, an on-vehicle network, such as controller area network (CAN), or a dedicated line.

The controller 11 includes one or more processors. In the embodiment, the “processor” is a general-purpose processor or a dedicated processor specialized for specific processing, but is not limited thereto. An electronic control unit (ECU) mounted on the vehicle 10 may function as the controller 11. The controller 11 is communicatively connected, for example, with each constituent unit constituting the vehicle 10, and controls the operation of the entire vehicle 10. In the embodiment, for example, the controller 11 controls each acquisition unit to acquire various kinds of information. For example, the controller 11 controls the communication unit 12 to transmit the acquired various kinds of information to the server 20 through the network 40.

The communication unit 12 includes a communication module that communicates through an on-vehicle network or a dedicated line. The communication unit 12 includes a communication module connected to the network 40. For example, the communication unit 12 may include a communication module compatible with mobile communication standards, such as 4th Generation (4G) and 5th Generation (5G). For example, an on-vehicle communication apparatus, such as data communication module (DCM), may function as the communication unit 12. In the embodiment, the vehicle 10 is connected to the network 40 through the communication unit 12.

The storage unit 13 includes one or more memories. In the embodiment, the “memory” is, for example, a semiconductor memory, a magnetic memory, or an optical memory, but is not limited thereto. Each memory included in the storage unit 13 may function as, for example, a main storage device, an auxiliary storage device, or a cache memory. The storage unit 13 stores predetermined information used for the operation of the vehicle 10. For example, the storage unit 13 may store a system program, an application program, road traffic information, road map information, various kinds of information acquired by each acquisition unit of the vehicle 10, and the like. The information stored in the storage unit 13 may be updatable based on, for example, information to be acquired from the network 40 through the communication unit 12.

The detection unit 14 detects the occurrence of the traffic accident related to the vehicle 10. In the embodiment, the detection unit 14 includes any sensor that can detect the occurrence of the traffic accident, such as light detecting and ranging (LIDAR), a radar, a sonar, a speed sensor, an acceleration sensor, a steering angle sensor, a pressure sensor, and a displacement sensor.

The configuration of the detection unit 14 is not limited to the content described above. The detection unit 14 may include an outside-vehicle camera for imaging the outside of the vehicle 10. The detection unit 14 may detect, for example, the occurrence of the traffic accident from a traveling image of the vehicle 10 captured by the outside-vehicle camera. The detection unit 14 may detect the occurrence of the traffic accident from the traveling image of the vehicle 10 captured by the outside-vehicle camera by using any image recognition technique.

The position information acquisition unit 15 acquires position information of the vehicle 10. In the embodiment, the position information acquisition unit 15 includes one or more receivers compatible with any satellite positioning system. For example, the position information acquisition unit 15 includes a global positioning system (GPS) receiver. At this time, the position information acquisition unit 15 acquires the position information of the vehicle 10 based on the GPS. The position information includes, for example, the latitude, the longitude, the altitude, and the traveling lane position. The position information acquisition unit 15 may always acquire the position information of the vehicle 10 or may periodically acquire the position information.

The configuration of the position information acquisition unit 15 is not limited to the content described above. The position information acquisition unit 15 may include a geomagnetic sensor, an angular acceleration sensor, and the like. At this time, the position information acquisition unit 15 may acquire the direction to which the vehicle 10 is directed.

The traveling state acquisition unit 16 acquires the traveling state of the vehicle 10. In the embodiment, the traveling state acquisition unit 16 includes an outside-vehicle camera for imaging the outside of the vehicle 10. The traveling state acquisition unit 16 acquires, for example, the traveling state of the vehicle 10 from the traveling image of the vehicle 10 captured by the outside-vehicle camera. At this time, the traveling state includes, for example, states, such as a speed, an inter-vehicle distance, and a traveling lane position. The traveling state acquisition unit 16 may always acquire the traveling state or may periodically acquire the traveling state.

The traveling state acquisition unit 16 may acquire the traveling state from the traveling image of the vehicle 10 captured by the outside-vehicle camera by using any image recognition technique.

The configuration of the traveling state acquisition unit 16 is not limited to the content described above. The traveling state acquisition unit 16 may include any sensor connected to the CAN. The sensor may include, for example, any sensor that can acquire the traveling state of the vehicle 10, such as a speed sensor, an acceleration sensor, and a steering angle sensor. The traveling state acquisition unit 16 may acquire, for example, the traveling state of the vehicle 10 from the output information output by the sensor. At this time, the traveling state is not limited to the content described above. In addition to the above, the traveling state may include any state that cannot be acquired by the traveling image of the vehicle 10 captured by the outside-vehicle camera, such as an acceleration, a steering state, an accelerator state, a brake state, a clutch state, a gear state, a blinker state, a wiper state, a light state, a door mirror state, and a seat state.

The occupant information acquisition unit 17 acquires information on the occupant in a cabin of the vehicle 10. In the embodiment, the occupant information acquisition unit 17 includes an in-vehicle cabin camera for imaging the inside of the cabin of the vehicle 10. The occupant information acquisition unit 17 acquires, for example, information on the occupant from an image captured by the in-vehicle cabin camera. At this time, the information on the occupant includes, for example, at least one of a state of a seat belt, a posture, a face direction, a line of sight, a blinking state, a gesture, the number, belongings, and a riding duration of the occupant, and attribute information including age, gender, and race. The occupant information acquisition unit 17 may always acquire the information on the occupant of the vehicle 10 or may periodically acquire the information.

The occupant information acquisition unit 17 may acquire the information on the occupant, such as the face direction, the line of sight, and the blinking state of the occupant, from the image captured by the in-vehicle cabin camera by using, for example, a face recognition technique. In addition, the occupant information acquisition unit 17 may acquire the information on the occupant from the image captured by the in-vehicle cabin camera by using any image recognition technique.

The configuration of the occupant information acquisition unit 17 is not limited to the content described above. The occupant information acquisition unit 17 may include any other image sensor, without being limited to the in-vehicle cabin camera. The occupant information acquisition unit 17 may include any other sensor, without being limited to the image sensor.

For example, the occupant information acquisition unit 17 may include any biological sensor installed in the cabin of the vehicle 10 and connected to the CAN. The occupant information acquisition unit 17 may acquire, for example, information on the occupant from the output information output by the biological sensor. At this time, the information on the occupant may include, for example, a biological state of the occupant including an electroencephalogram, a cerebral blood flow, a blood pressure, a blood sugar level, a blood amino acid, a heart rate, a pulse, a body temperature, a sensible temperature, a fatigue, and the like.

For example, the occupant information acquisition unit 17 may include any sound sensor installed in the cabin of the vehicle 10 and connected to the CAN. The occupant information acquisition unit 17 may acquire, for example, information on the occupant from the output information output by the sound sensor. At this time, the information on the occupant may include, for example, sound information caused by the occupant including, for example, a conversation content between the occupants, a voice generated by the occupant's behavior for expressing other voice language, a sound generated by the occupant's behavior for expressing other sound, and the like.

The occupant information acquisition unit 17 may acquire the information on the occupant from the output information output by the sound sensor by using, for example, a voice recognition technique and any other recognition technique.

Server

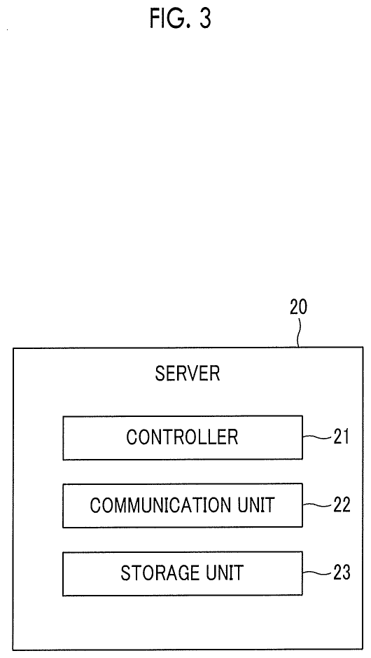

FIG. 3 is a block diagram showing a schematic configuration of the server 20. As shown in FIG. 3, the server 20 includes a controller 21, a communication unit 22, and a storage unit 23.

The controller 21 includes one or more processors. The controller 21 is connected with each constituent unit constituting the server 20 and controls the operation of the entire server 20. For example, the controller 21 controls the communication unit 22 to acquire various kinds of information from the vehicle 10 through the network 40. For example, the controller 21 controls the storage unit 23 to store information needed for the operation of the information processing system 1 in the storage unit 23.

The communication unit 22 includes a communication module connected to the network 40. For example, the communication unit 22 may include a communication module compatible with a wired local area network (LAN) standard. In the embodiment, the server 20 is connected to the network 40 through the communication unit 22.

The storage unit 23 includes one or more memories. Each memory included in the storage unit 23 may function as, for example, a main storage device, an auxiliary storage device, or a cache memory. The storage unit 23 stores predetermined information used for the operation of the server 20. For example, the storage unit 23 may store a system program, an application program, road traffic information, road map information, various kinds of information acquired by each acquisition unit of the vehicle 10, and the like. The storage unit 23 stores other information needed for the operation of the information processing system 1.

For example, the storage unit 23 stores the provision information. The provision information includes position information of a point P at which the traffic accident has occurred, which is acquired by the position information acquisition unit 15 of the vehicle 10. The provision information further includes the traveling state of the vehicle 10 acquired by the traveling state acquisition unit 16 of the vehicle 10 and the information on the occupant acquired by the occupant information acquisition unit 17 of the vehicle 10. The provision information further includes the damage state of the vehicle 10 due to the traffic accident and the kind of traffic accident analyzed based on the traveling state of the vehicle 10, and the injury state of the occupant due to the traffic accident analyzed based on the information on the occupant. The provision information further includes a degree of damage of the vehicle 10 and a degree of injury of the occupant described below.

The provision information may be managed as big data, for example, by aggregating all data on various past traffic accidents related to a plurality of vehicles 10 in the server 20. The information stored in the storage unit 23 may be updatable based on, for example, information to be acquired from the network 40 through the communication unit 22.

The controller 21 analyzes the damage state of the vehicle 10 due to the traffic accident based on the traveling state of the vehicle 10 acquired by the traveling state acquisition unit 16 of the vehicle 10. At this time, the controller 21 analyzes the kind of traffic accident in addition to the damage state of the vehicle 10 due to the traffic accident. The kind of traffic accident includes, for example, any kind, such as a contact accident and a head-on collision accident described below.

In addition to the traveling state of the vehicle 10 acquired by the traveling state acquisition unit 16 of the vehicle 10, the controller 21 may analyze the damage state of the vehicle 10 based on the traveling image acquired from another vehicle traveling around the point P at which the traffic accident has occurred. For example, the controller 21 may analyze the damage state of the vehicle 10 due to the traffic accident based on the traveling state of the vehicle 10 before the occurrence of the traffic accident and the state of the vehicle 10 at the moment of and immediately after the occurrence of the traffic accident, which have been recorded by an outside-vehicle camera included in the other vehicle. The controller 21 may analyze the kind of traffic accident in the same manner.

The controller 21 analyzes the injury state of the occupant due to the traffic accident based on the information on the occupant acquired by the occupant information acquisition unit 17 of the vehicle 10. In a case where a plurality of occupants of the vehicle 10 is present, the controller 21 may analyze the injury state for each occupant or may analyze the injury state of a specific occupant.

The controller 21 may execute the analysis processing by, for example, machine learning. The controller 21 may have any configuration for learning processing to execute the analysis processing. When a notification of the occurrence of the traffic accident is received from the vehicle 10, the controller 21 generates provision information including the damage state of the vehicle 10 due to the traffic accident analyzed based on the traveling state of the vehicle 10 and the injury state of the occupant due to the traffic accident analyzed based on the information on the occupant, and stores the generated provision information in the storage unit 23.

The controller 21 calculates the degree of damage of the vehicle 10 due to the traffic accident based on the traveling state of the vehicle 10 acquired by the traveling state acquisition unit 16 of the vehicle 10. The degree of damage of the vehicle 10 may be calculated based on any index. For example, the degree of damage of the vehicle 10 may be represented by any one of four levels “none”, “small”, “medium”, and “large”. The degree of damage of the vehicle 10 is not limited thereto, and may be represented by a numerical value of, for example, zero to 100. Thus, the degree of damage of the vehicle 10 may be represented by a numerical value within any numerical range. At this time, the larger the value of the degree of damage of the vehicle 10, the larger the damage of the vehicle 10 due to the traffic accident. Conversely, the smaller the value of the degree of damage of the vehicle 10, the smaller the damage to the vehicle 10 due to the traffic accident.

The controller 21 calculates the degree of injury of the occupant due to the traffic accident based on the information on the occupant acquired by the occupant information acquisition unit 17 of the vehicle 10. The degree of injury of the occupant may be calculated based on any index. For example, the degree of injury of the occupant may be represented by any one of four levels “none”, “small”, “medium”, and “large”. The degree of injury of the occupant is not limited thereto, and may be represented by a numerical value of, for example, zero to 100. Thus, the degree of injury of the occupant may be represented by a numerical value within any numerical range. At this time, the larger the degree of injury of the occupant, the larger the injury of the occupant due to the traffic accident. Conversely, the smaller the degree of injury of the occupant, the smaller the injury of the occupant due to the traffic accident. In a case where a plurality of occupants of the vehicle 10 is present, the controller 21 may calculate the degree of injury for each occupant or may calculate the degree of injury as an average value for all the occupants.

The controller 21 provides the generated provision information to the insurance company. For example, the controller 21 transmits the provision information to the information processing terminal 30 of the insurance company by using the communication unit 22. The provision method of the provision information by the controller 21 is not limited thereto. For example, the controller 21 may set the provision information stored in the storage unit 23 to be browsable by the employee of the insurance company based on the access to the server 20 through the network 40.

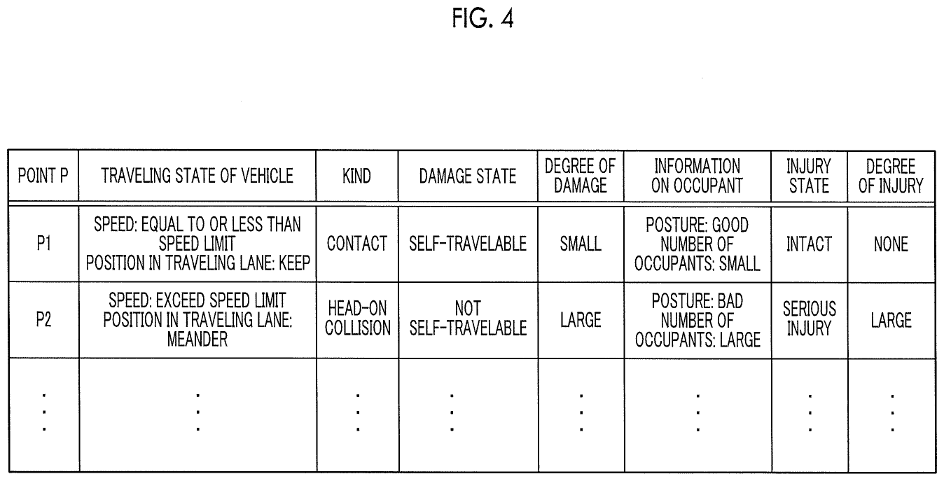

FIG. 4 is a table showing a specific example of the provision information stored in the storage unit 23 of the server 20. The provision information to be provided to the insurance company by the information processing system 1 will be more specifically described with reference to FIG. 4. In FIG. 4, for convenience of the description, solely representative points P1, P2 are exemplified for the points P at which the traffic accidents related to the vehicles 10 have occurred. However, an applicable embodiment of the present disclosure is not limited thereto, and the point P at which the traffic accident has occurred may include a plurality of points other than the points P1, P2 or may include any one of the points P1, P2.

For example, in the point P1 at which the traffic accident has occurred, the provision information stored in the storage unit 23 and provided to the insurance company includes the traveling state of the vehicle 10, the kind of traffic accident, the damage state of the vehicle 10, the degree of damage of the vehicle 10, the information on the occupant, the injury state of the occupant, and the degree of injury of the occupant. More specifically, in the traffic accident at the point P1, a speed of the vehicle 10 was equal to or less than a speed limit and a position of the vehicle 10 in a traveling lane was kept constant. The kind of traffic accident was a minor contact accident with a parallel traveling vehicle or an oncoming vehicle. At this time, the damage state of the vehicle 10 was “self-travelable” and the degree of damage of the vehicle 10 was “small”. In the traffic accident at the point P1, a posture of the occupant was good and the number of the occupants was small. At this time, the injury state of the occupant was “intact” and the degree of injury of the occupant was “none”.

For example, the insurance company acquires the provision information associated with the point P1 from the information processing system 1 immediately after the occurrence of the traffic accident. For example, in the traffic accident at the point P1, the insurance company accurately grasps that the vehicle 10 is self-travelable and the occupant is intact based on the provision information from the information processing system 1. For example, the insurance company gets in touch with the party of the traffic accident at the point P1 to provide a countermeasure for the traffic accident. For example, the insurance company determines that the traffic accident at the point P1 is minor and can also appropriately advise the party that there is no problem in dealing with the accident by performing an emergency repair for the vehicle 10.

For example, in the point P2 at which the traffic accident has occurred, the provision information stored in the storage unit 23 and provided to the insurance company includes the traveling state of the vehicle 10, the kind of traffic accident, the damage state of the vehicle 10, the degree of damage of the vehicle 10, the information on the occupant, the injury state of the occupant, and the degree of injury of the occupant. More specifically, in the traffic accident at the point P2, the speed of the vehicle 10 exceeded the speed limit, and the vehicle 10 meandered with respect to the traveling lane. The kind of traffic accident was a head-on collision accident with an oncoming vehicle. At this time, the damage state of the vehicle 10 was “not self-travelable” and the degree of damage of the vehicle 10 was “large”. In the traffic accident at the point P2, the posture of the occupant was bad and the number of the occupants was large. At this time, the injury state of the occupant was “serious injury” and the degree of injury of the occupant was “large”.

For example, the insurance company acquires the provision information associated with the point P2 from the information processing system 1 immediately after the occurrence of the traffic accident. For example, in the traffic accident at the point P2, the insurance company accurately grasps that the vehicle 10 is not self-travelable and the occupant is seriously injured based on the provision information from the information processing system 1. For example, the insurance company gets in touch with the party of the traffic accident at the point P2 to provide a countermeasure for the traffic accident. For example, the insurance company determines that the traffic accident at the point P2 is severe and can also appropriately advise that the party that arrangements for a wrecker and an ambulance are urgently needed.

As described above, the insurance company can accurately grasp the situation of the traffic accident based on the provision information as shown in FIG. 4 and provide an appropriate countermeasure to the party for each traffic accident.

Operation Flow of Information Processing System

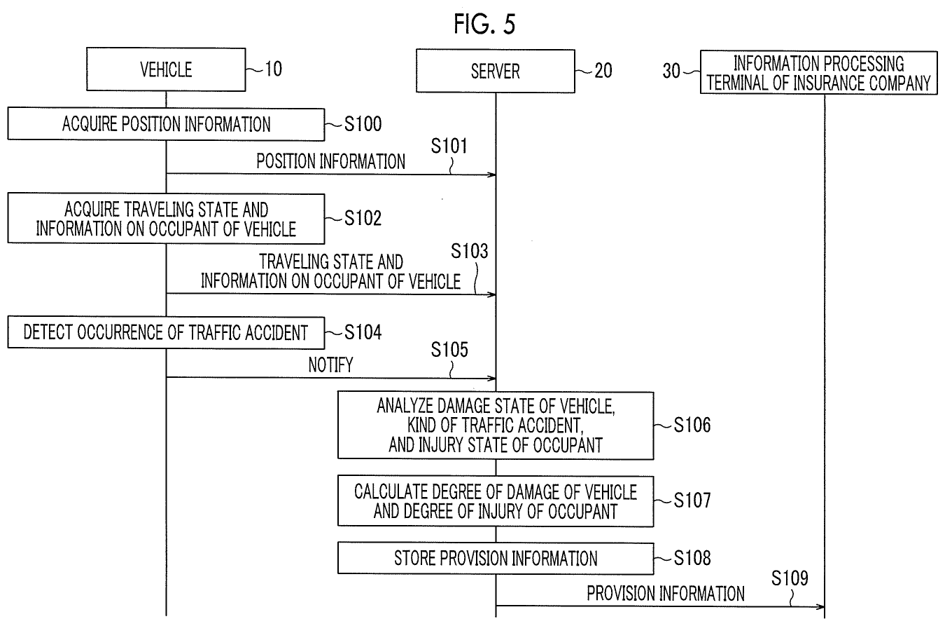

FIG. 5 is a sequence diagram showing an example of an operation flow of the information processing system 1. The example of the operation flow of the information processing system 1 will be described with reference to FIG. 5.

Step S100: The controller 11 of the vehicle 10 causes the position information acquisition unit 15 to acquire the position information of the vehicle 10.

Step S101: The controller 11 of the vehicle 10 transmits the position information of the vehicle 10 acquired in Step S100 to the server 20 by the communication unit 12. For example, the controller 21 of the server 20 may always acquire the position information of the vehicle 10 from the communication unit 12 or may appropriately acquire the position information at a predetermined timing.

Step S102: The controller 11 of the vehicle 10 causes the traveling state acquisition unit 16 to acquire the traveling state of the vehicle 10. The controller 11 of the vehicle 10 causes the occupant information acquisition unit 17 to acquire the information on the occupant of the vehicle 10.

Step S103: The controller 11 of the vehicle 10 transmits the traveling state and the information on the occupant of the vehicle 10 acquired in Step S102 to the server 20 by the communication unit 12. For example, the controller 21 of the server 20 may always acquire the traveling state and the information on the occupant of the vehicle 10 from the communication unit 12 or may appropriately acquire the traveling state and the information on the occupant at a predetermined timing.

Step S104: The controller 11 of the vehicle 10 detects the occurrence of the traffic accident related to the vehicle 10 by the detection unit 14.

Step S105: The controller 11 of the vehicle 10 notifies the server 20 of the occurrence of the traffic accident detected in Step S104 by the communication unit 12.

When a notification of the occurrence of the traffic accident is received from the vehicle 10 in Step S105, the controller 21 of the server 20 executes processing from Step S106 to Step S109 described below.

Step S106: The controller 21 of the server 20 analyzes the damage state of the vehicle 10 due to the traffic accident and the kind of traffic accident based on the traveling state of the vehicle 10. The controller 21 of the server 20 analyzes the injury state of the occupant due to the traffic accident based on the information on the occupant.

Step S107: The controller 21 of the server 20 calculates the degree of damage of the vehicle 10 due to the traffic accident based on the traveling state of the vehicle 10. The controller 21 of the server 20 calculates the degree of injury of the occupant due to the traffic accident based on the information on the occupant.

Step S108: The controller 21 of the server 20 stores the provision information including the damage state of the vehicle 10 and the injury state of the occupant analyzed in Step S106.

Step S109: The controller 21 of the server 20 provides the provision information stored in Step S108 to the insurance company.

As described above, with the information processing system 1 according to the embodiment, it is possible to contribute to the appropriate decision of the countermeasure provided by the insurance company to the party when the traffic accident occurs. The insurance company acquires, from the information processing system 1, the provision information including the damage state of the vehicle 10 and the injury state of the occupant of the vehicle 10 due to the occurrence of the traffic accident, thereby providing an appropriate countermeasure to the party of the traffic accident. For example, even in a case where the party is confused by the occurrence of the traffic accident and it is difficult to directly grasp a damage situation and an injury situation caused by the traffic accident from the party, the insurance company can appropriately grasp these situations based on the provision information from the information processing system 1.

The provision information includes the position information of the point P at which the traffic accident has occurred, whereby the insurance company can appropriately decide the countermeasure to be provided to the party of the traffic accident also based on information, such as a geographical condition and a traveling environment around the point P. For example, the insurance company or the information processing system 1 can estimate the time before an emergency vehicle, such as an ambulance, arrives based on the position information of the point P. The insurance company can appropriately decide the countermeasure, such as an emergency repair and first aid, to be performed by the party before the emergency vehicle arrives based on such an estimated time.

The information processing system 1 analyzes the damage state of the vehicle 10 and the kind of traffic accident based on the traveling image acquired from another vehicle traveling around the point P at which the traffic accident has occurred, whereby the accuracy of these analyses is improved. For example, in addition to the traveling image acquired by the outside-vehicle camera of the vehicle 10, the information processing system 1 can execute analysis from a plurality of viewpoints based on the traveling image acquired from the other vehicle traveling around the point P. In addition, even though the traveling state of the vehicle 10 up to the point P cannot appropriately acquired from the traveling state acquisition unit 16 due to a failure caused by the traffic accident, the information processing system 1 can accurately acquire the traveling state of the vehicle 10 based on the traveling image acquired from the other vehicle traveling around the point P.

The provision information includes the kind of traffic accident analyzed by the server 20 based on the traveling state of the vehicle 10, whereby the insurance company accurately grasps the kind of traffic accident to more appropriately decide the countermeasure to be provided to the party of the traffic accident. For example, the countermeasure is usually different depending on whether the occurred traffic accident is a property damage accident or a personal injury accident. The insurance company can decide the countermeasure according to the kind of traffic accident at that time as occasion demands.

The information processing system 1 acquires the traveling state of the vehicle 10 from the traveling image of the vehicle 10 captured by the outside-vehicle camera, thereby acquiring the traveling state of the vehicle 10 before the occurrence of the traffic accident as visual information. The insurance company acquires the traveling state of the vehicle 10 based on such visual information as the provision information, thereby visually grasping the situation before the occurrence of the traffic accident.

The information processing system 1 acquires the information on the occupant from the image captured by the in-vehicle cabin camera, thereby accurately acquiring the information on the occupant based on the visual information. The information processing system 1 acquires the information on the occupant from the output information output by any sensor capable of acquiring the information on the occupant, thereby acquiring various kinds of information on the occupant that cannot be acquired based on the visual information. For example, the information processing system 1 can acquire, from the output information output by the biological sensor, the biological state of the occupant that cannot be acquired based on the visual information. For example, the information processing system 1 can acquire, from the output information output by the sound sensor, the sound information caused by the occupant that cannot be acquired based on the visual information.

The information processing system 1 transmits the provision information to the information processing terminal 30 of the insurance company, whereby the convenience of the employee in the insurance company is improved. The employee in the insurance company can easily obtain the information needed for deciding the countermeasure when the traffic accident occurs, without accessing the server 20.

An applicable embodiment of the present disclosure has been described based on the drawings and the examples, but it is to be noted that those skilled in the art easily perform various modifications and changes based on this disclosure. Therefore, it is to be noted that these modifications and changes are included in the scope of the present disclosure. For example, the functions and the like included in each unit, each step, or the like can be disposed again so as not to be logically contradictory, and a plurality of units, steps, or the like can be combined into one, or divided.

For example, in the embodiment described above, each constituent unit of the vehicle 10 has been described as being mounted on the vehicle 10. However, some or all of the processing operations to be executed by each constituent unit of the vehicle 10 may be executed by any electronic apparatus, such as a smartphone or a computer.

A general electronic apparatus, such as a smartphone or a computer, can be configured to function as each constituent unit of the vehicle 10 or the server 20 according to the embodiment described above. For example, a program, in which processing contents for realizing each function of the communication unit 12 or the like according to the embodiment are described, is stored in a memory of the electronic apparatus and causes a processor of the electronic apparatus to read and execute the program. Therefore, an applicable embodiment of the present disclosure can also be realized as the program that can be executed by the processor.

In the embodiment described above, the information processing system 1 has been described to calculate the degree of damage of the vehicle 10 based on the traveling state of the vehicle 10. However, the information calculated based on the traveling state of the vehicle 10 is not limited to the degree of damage of the vehicle 10. The information calculated based on the traveling state of the vehicle 10 may be any index that objectively reflects the damage state of the vehicle 10 due to the traffic accident.

In the embodiment described above, the information processing system 1 has been described to calculate the degree of injury of the occupant based on the information on the occupant of the vehicle 10. However, the information calculated based on the information on the occupant is not limited to the degree of injury of the occupant. The information calculated based on the information on the occupant may be any index that objectively reflects the injury state of the occupant due to the traffic accident.

In the embodiment described above, the provision information has been described to include the position information of the point P at which the traffic accident has occurred, the traveling state of the vehicle 10, the kind of traffic accident, the damage state of the vehicle 10, the degree of damage of the vehicle 10, the information on the occupant, the injury state of the occupant, and the degree of injury of the occupant. The provision information is not limited thereto, and may include at least one of these kinds of information. For example, the provision information may include at least the damage state of the vehicle 10 and the injury state of the occupant. For example, the provision information may include at least the degree of damage of the vehicle 10 and the degree of injury of the occupant. The information processing system 1 may execute analysis processing or calculation processing solely for the items included in the provision information.

What is claimed is:

1. An information processing system comprising:
a vehicle; and
a server communicatively connected with the vehicle, wherein:
the vehicle is configured to
acquire a traveling state of the vehicle,
acquire information on an occupant of the vehicle, and
detect an occurrence of a traffic accident related to the vehicle; and
the server is configured to, when a notification of the occurrence of the traffic accident is received from the vehicle,
store provision information including a damage state of the vehicle due to the traffic accident analyzed based on the traveling state of the vehicle and an injury state of the occupant due to the traffic accident analyzed based on the information on the occupant, and provide the provision information to an insurance company.

2. The information processing system according to claim 1, wherein the vehicle is configured to acquire position information of the vehicle, and the provision information includes the position information of a point at which the traffic accident has occurred.

3. The information processing system according to claim 2, wherein the server is configured to analyze the damage state of the vehicle based on a traveling image acquired from another vehicle traveling around the point at which the traffic accident has occurred.

4. The information processing system according to claim 1, wherein the provision information includes a kind of the traffic accident analyzed by the server based on the traveling state of the vehicle.

5. The information processing system according to claim 1, wherein the vehicle includes an outside-vehicle camera for imaging an outside of the vehicle, and is configured to acquire the traveling state of the vehicle from a traveling image of the vehicle captured by the outside-vehicle camera.

6. The information processing system according to claim 1, wherein the vehicle includes an in-vehicle cabin camera for imaging an inside of a cabin of the vehicle, and is configured to acquire the information on the occupant from an image captured by the in-vehicle cabin camera.

7. The information processing system according to claim 1, wherein the server is configured to transmit the provision information to an information processing terminal of the insurance company.

8. A program that operates in an information processing system including a vehicle and a server communicatively connected with the vehicle, the program causing
the vehicle to execute:
a step of acquiring a traveling state of the vehicle;
a step of acquiring information on an occupant of the vehicle; and
a step of detecting an occurrence of a traffic accident related to the vehicle, and
the server to execute:
a step of receiving a notification of the occurrence of the traffic accident from the vehicle; and
a step of storing provision information including a damage state of the vehicle due to the traffic accident analyzed based on the traveling state of the vehicle and an injury state of the occupant due to the traffic accident analyzed based on the information on the occupant, and providing the provision information to an insurance company.

9. A control method in an information processing system including a vehicle and a server communicatively connected with the vehicle, the control method comprising:
in the vehicle,
a step of acquiring a traveling state of the vehicle;
a step of acquiring information on an occupant of the vehicle; and
a step of detecting an occurrence of a traffic accident related to the vehicle; and
in the server,
a step of receiving a notification of the occurrence of the traffic accident from the vehicle; and
a step of storing provision information including a damage state of the vehicle due to the traffic accident analyzed based on the traveling state of the vehicle and an injury state of the occupant due to the traffic accident analyzed based on the information on the occupant, and providing the provision information to an insurance company.
